(19) United States
(12) Patent Application Publication
(10) Pub. No.: US 2023/0046814 A1
(43) Pub. Date: Feb. 16, 2023

(54) METHOD AND SYSTEM FOR CONDITIONING VEHICLE BATTERY INTERWORKING WITH SCHEDULED AIR CONDITIONING

(71) Applicants: Hyundai Motor Company, Seoul (KR); Kia Corporation, Seoul (KR)

(72) Inventors: Jin Gyu Lim, Gumi-si (KR); Hyun Soo Park, Gumi-si (KR); Dea Ki Cheong, Yongin-si (KR); Tae Hyuck Kim, Seoul (KR); Tae Geun Jeong, Seoul (KR); Dae Kyung Kim, Seoul (KR); Dae Gun Jin, Suwon-si (KR); Joong Woo Lee, Yongin-si (KR); In Seok Park, Seoul (KR); Seung Myun Chung, Seoul (KR); Ki Seung Baek, Hwaseong-si (KR)

(73) Assignees: Hyundai Motor Company, Seoul (KR); Kia Corporation, Seoul (KR)

(21) Appl. No.: 17/812,418

(22) Filed: Jul. 13, 2022

(30) Foreign Application Priority Data
Aug. 11, 2021 (KR) 10-2021-0106290

(51) Int. Cl. B60L 58/27; B60H 1/00

(52) U.S. Cl. CPC B60L 58/27; B60H 1/00385; B60H 1/0073; B60H 1/00985

(57) ABSTRACT

Disclosed is a method for conditioning a vehicle battery interworking with scheduled air conditioning, including the steps of determining, using a controller, whether a scheduled departure time and scheduled air conditioning execution are set after parking a vehicle; determining, using the controller, whether battery conditioning execution of the vehicle is set when it is determined that the scheduled departure time and the scheduled air conditioning are set; and executing, using the controller, air conditioning and battery conditioning of the vehicle before a preset reference time of the scheduled departure time when the battery conditioning execution is set.

### CROSS REFERENCE TO RELATED APPLICATION

The present application claims, under 35 U.S.C. § 119(a), the benefit of Korean Patent Application No. 10-2021-0106290, filed Aug. 11, 2021, the entire contents of which is incorporated herein in its entirety.

### BACKGROUND

### Technical Field

Embodiments of the present disclosure relate to a system and a method for conditioning a vehicle battery interworking with scheduled air conditioning and, more particularly, to a system and a method for conditioning a vehicle battery interworking with scheduled air conditioning capable of optimizing battery charging performance by appropriately controlling the battery temperature of a parked vehicle interworking with the scheduled air conditioning of the vehicle.

### Description of the Related Art

With the proliferation of electric cars, and plug-in hybrid vehicles growing rapidly in recent years, the matter of battery charging time, which is one of the obstacles in operating a vehicle, is very important. In general, the charging time of a lithium-ion battery mounted in a vehicle varies greatly depending on whether the battery is preheated or not. When the battery temperature is a room temperature by performing so-called battery conditioning in which the battery is preheated in advance, the charging time during rapid charging of the vehicle is dramatically reduced.

Conventionally, as a method of increasing battery temperature, there is a winter mode function for securing driving performance at a low temperature and is an essential function for driving a vehicle when an outside temperature is extremely low, and it is far from securing charging performance such as shortening the battery charging time when rapidly charging the vehicle battery. However, in order to secure the charging performance of the battery, a certain temperature of the battery must be secured, but setting the optimal battery temperature all the time consumes a lot of energy. Therefore, many technological developments have been made in increasing the battery temperature without consuming much energy in the conventional method of increasing the battery temperature.

A scheduled air conditioning means that, when a user sets a scheduled departure time, a vehicle operates according to a target temperature at a corresponding time. In order to prevent a decrease in the state of charge of the battery due to always setting an optimal battery temperature, a battery temperature increase strategy that activates a battery conditioning function when a slow charging connector is connected before the vehicle starts has been introduced.

The matters described as the existing technologies above are only for improving the understanding of the background of the present disclosure, and should not be taken as an acknowledgment that they correspond to the existing technologies already known to those of ordinary skill in the art.

### SUMMARY

Embodiments of the present disclosure have been made in view of the above problems, and it is an object of the present disclosure to provide systems and methods for conditioning a vehicle battery interworking with scheduled air conditioning capable of optimizing battery performance by increasing a battery temperature in advance before driving the vehicle, interworking with the scheduled air conditioning set in the vehicle.

To accomplish the above object, according to an exemplary embodiment of the present disclosure, there is provided a method for conditioning a vehicle battery interworking with scheduled air conditioning, including the steps of determining, using a controller, whether a scheduled departure time and scheduled air conditioning execution are set after parking a vehicle; determining, using the controller, whether battery conditioning execution of the vehicle is set when it is determined that the scheduled departure time and the scheduled air conditioning are set; and executing, using the controller, air conditioning and battery conditioning of the vehicle before a preset reference time of the scheduled departure time when the battery conditioning execution is set.

In an exemplary embodiment of the present disclosure, the step of determining, using the controller, whether a charging connector for receiving a charging power from outside is connected to charge the battery may be further included.

In an exemplary embodiment of the present disclosure, when it is determined that the charging connector is not connected, the controller may be configured to not execute the scheduled air conditioning and battery conditioning of the vehicle.

In an exemplary embodiment of the present disclosure, in the step of executing, the controller may be configured to execute indoor air conditioning of the vehicle to a temperature set in the setting of the scheduled air conditioning execution, and may be configured to increase the temperature of the battery to a preset reference temperature.

In an exemplary embodiment of the present disclosure, in the step of executing, the controller may be configured to compare the temperature set in the setting of the scheduled air conditioning execution with a measured indoor temperature of the vehicle, forming a first comparison, and may be configured to turn on/off indoor ventilation according to the first comparison to control an indoor temperature of the vehicle to be maintained to the temperature set in the setting of the scheduled air conditioning execution, and the controller may be configured to compare the preset reference temperature with a measured temperature of the battery, forming a second comparison, and may be configured to turn on/off power of a battery heater provided in the battery according to the second comparison to control the temperature of the battery to be maintained to the reference temperature.

In an exemplary embodiment of the present disclosure, the executing includes transmitting and displaying, using the controller, statuses of the scheduled air conditioning execution and battery conditioning execution to a remote communication terminal.

In an exemplary embodiment of the present disclosure, in the step of executing, the controller may be configured to calculate a start time of the air conditioning and battery conditioning of the vehicle by inverse calculation based on the scheduled departure time, and may be configured to execute the air conditioning and battery conditioning of the vehicle, respectively, at the calculated start time of the air conditioning and battery conditioning of the vehicle.

In order to solve the technical object, the present disclosure provides a system for conditioning a vehicle battery interworking with scheduled air conditioning, including an interface unit that is configured to receive a scheduled departure time setting, a scheduled air conditioning execution setting, and a conditioning execution setting of a battery in a vehicle after parking the vehicle; and a controller that is configured to determine whether the scheduled departure time setting, the scheduled air conditioning execution setting, and the conditioning execution setting of the battery in the vehicle are received, and, based on a resulting determination, indoor air conditioning and the battery conditioning of the vehicle may execute or does not execute before the scheduled departure time.

In an exemplary embodiment of the present disclosure, the controller may be configured to execute the battery conditioning when the scheduled departure time setting and the scheduled air conditioning execution setting are input.

In an exemplary embodiment of the present disclosure, the controller may be configured to determine whether a charging connector for receiving a charging power from outside is connected to charge the battery, and may be configured to execute the scheduled air conditioning and battery conditioning of the vehicle when it is determined that the charging connector is connected.

In an exemplary embodiment of the present disclosure, when the indoor air conditioning and battery conditioning of the vehicle are executed before the scheduled departure time, the controller may be configured to execute the indoor air conditioning of the vehicle to a temperature set in the scheduled air conditioning execution setting and may be configured to increase a temperature of the battery to a preset reference temperature.

In an exemplary embodiment of the present disclosure, the controller may be configured to compare the temperature set in the scheduled air conditioning execution setting with a measured indoor temperature of the vehicle, forming a first comparison, and may be configured to turn on/off indoor ventilation according to the first comparison to control an indoor temperature of the vehicle to be maintained to the temperature set in the scheduled air conditioning execution setting, and the controller may be configured to compare the preset reference temperature with a measured temperature of the battery, forming a second comparison, and may be configured to turn on/off power of a battery heater provided in the battery according to the second comparison to control the temperature of the battery to be maintained to the reference temperature.

In an exemplary embodiment of the present disclosure, a communication terminal that is configured to receive and display statues of the scheduled air conditioning execution and battery conditioning execution through the interface unit may be further included.

According to the method and system for conditioning a vehicle battery interworking with scheduled air conditioning, the temperature of the battery may be appropriately controlled, in advance, interworking with the scheduled air conditioning of the vehicle, that is, the indoor air conditioning performed in advance during parking before departure of the vehicle.

Through above-mentioned, according to the methods and systems for conditioning a vehicle battery, interworking with scheduled air conditioning, the charging performance can be secured by increasing the battery temperature before charging the high-voltage battery of the vehicle.

In addition, according to the methods and systems for conditioning a vehicle battery interworking with scheduled air conditioning, the status of the battery conditioning execution may be displayed through the driver terminal when the battery conditioning is executed, interworking with the scheduled air conditioning, so that the driver can be aware that the battery is always managed in the vehicle, and reliability of the product may be improved.

In addition, according to the methods and systems for conditioning a vehicle battery interworking with scheduled air conditioning, if the next departure time is set at the end of vehicle driving and only whether the scheduled air conditioning execution and conditioning execution are set in advance, the temperature of the battery may be automatically increased. Considering the characteristic that a lithium-ion battery mainly employed as a vehicle battery has a large specific heat, the methods and systems for conditioning a vehicle battery, interworking with scheduled air conditioning, according to an exemplary embodiment of the present disclosure, may effectively control the battery temperature in terms of energy compared to the method in which the battery temperature is increased through a driver's separate manual operation.

The effects obtainable in the present disclosure are not limited to the above-mentioned effects, and other effects not mentioned could be clearly understood by those of ordinary skill in the art from the following description.

### BRIEF DESCRIPTION OF THE DRAWINGS

The above and other aspects, features, and advantages of the present disclosure will be more clearly understood from the following detailed description taken in conjunction with the accompanying drawings, in which:

FIG. 1 is a block diagram illustrating an example of a system for conditioning a vehicle battery interworking with scheduled air conditioning according to an exemplary embodiment of the present disclosure;

FIG. 2 is a flowchart illustrating a method for conditioning a vehicle battery interworking with scheduled air conditioning according to an exemplary embodiment of the present disclosure;

FIGS. 3 to 8 are views illustrating examples of a setting screen displayed on an Audio Video Navigation (AVN) of a head unit of a vehicle in a system and method for conditioning a vehicle battery interworking with scheduled air conditioning according to an exemplary embodiment of the present disclosure; and

FIG. 9 is a view illustrating an example of a screen displaying the statues of the scheduled air conditioning execution and battery conditioning execution displayed on a driver terminal in a system and method for conditioning a vehicle battery interworking with scheduled air conditioning according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

Furthermore, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Hereinafter, methods and systems for conditioning a vehicle battery interworking with scheduled air conditioning according to various embodiments of the present disclosure will be described in detail with reference to the accompanying drawings.

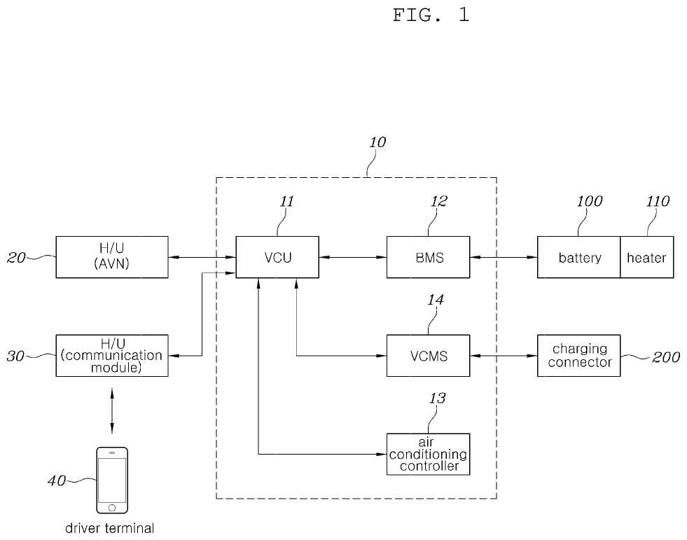

FIG. 1 is a block diagram illustrating an example of a system for conditioning a vehicle battery interworking with scheduled air conditioning according to an exemplary embodiment of the present disclosure.

Referring to FIG. 1, a system for conditioning a vehicle battery interworking with scheduled air conditioning according to an exemplary embodiment of the present disclosure is configured to include interface units 20, 30 that are configured to receive a scheduled departure time setting and scheduled air conditioning execution setting of a vehicle, and a controller 10 that is configured to turn on an air conditioner of the vehicle before a preset time other than the set scheduled departure time when the scheduled air conditioning execution is set, and is configured to increase a temperature of a battery 100 when the temperature of the battery 100 in the vehicle is lower than a preset reference value.

The interface units 20, 30 are devices called a Head Unit (H/U) provided in the interior of the vehicle and may include an Audio Video Navigation (AVN) 20 that is configured to provide a driver with an interface that can be input through a button or a touch screen, or a communication module 30 that is configured to transmit an input provided by the driver to a terminal 40 through communication with the driver terminal 40.

The interface units 20, 30 may be configured to receive inputs from the driver, such as the scheduled departure time setting, the setting related to whether to execute the scheduled air conditioning, the setting of the battery conditioning mode corresponding to a temperature increase through heating the battery, and transmit the input setting to the controller 10.

On the other hand, the driver terminal 40 is a communication terminal that may be configured to receive the vehicle status through wireless communication at a remote distance from the vehicle, and may be configured to transmit the vehicle status and cause a screen to display the vehicle status to be displayed by executing an application installed therein.

Communication with the driver terminal 40 and screen display through execution of the application in the driver terminal 40 may be achieved by various communication techniques and applications already known in existing technologies, and detailed description thereof will be omitted.

The controller 10 may include a plurality of control units or control systems related to performing the vehicle battery conditioning interworking with the scheduled air conditioning according to an exemplary embodiment of the present disclosure.

The controller 10 may include a Vehicle Control Unit (VCU) 11 that is configured to perform overall control related to vehicle operation, such as charging and driving of the vehicle, a Battery Management System (BMS) 12 that is configured to collect battery information such as voltage, current, and Status Of Charge (SOC) of the battery 100, and control whether a battery heater 110 for heating the battery 100 provided in the battery 100 is operated, an air conditioning controller 13 that is configured to control an air controlling device of the vehicle, a Vehicle Charging Management System (VCMS) 14 that is configured to determine a control related to the charging of the battery 100, such as control of the charger for charging the battery 100, in particular, determine whether a charging connector for receiving charging power from outside is connected to charge the battery 100, and the like.

In various embodiments of the present disclosure, the controller 10 may be implemented as a single controller or control system provided in a vehicle, but this can be understood as a concept that encompasses various control units and management systems that perform control operations to implement the technique of the vehicle battery conditioning interworking with the scheduled air conditioning in various mass-produced vehicles.

The VCU 11 may be configured to provide various commands or instructions for the scheduled air conditioning execution and the battery conditioning execution to other controllers based on the settings inputted from the interface units 20, 30, and may be configured to determine whether the requirements for the scheduled air conditioning execution or the battery conditioning execution is satisfied.

The BMS 12 may be configured to collect battery information through battery monitoring and provide it to the VCU 11. For example, the BMS 12 may be configured to provide the battery temperature, the status of charge of the battery, and whether the battery heater 110 operates to the vehicle management system. In addition, it is possible to determine whether to supply power to the controller in the vehicle according to a command of the BMS 12, and control whether the battery heater 110 operates.

The air conditioning controller 13 may be configured to control the air conditioner of the vehicle based on the command of the VCU 11. For example, the air conditioning controller 13 may be configured to operate the air conditioner based on the information on the scheduled air conditioning setting provided from the VCU 11, and limit the output of the air conditioner according to the air conditioning output limit command provided from the VCU 11.

The VCMS 14 may provide to the vehicle controller 11 whether a charging outlet of an external charging facility is connected to a charging connector 200 of the vehicle.

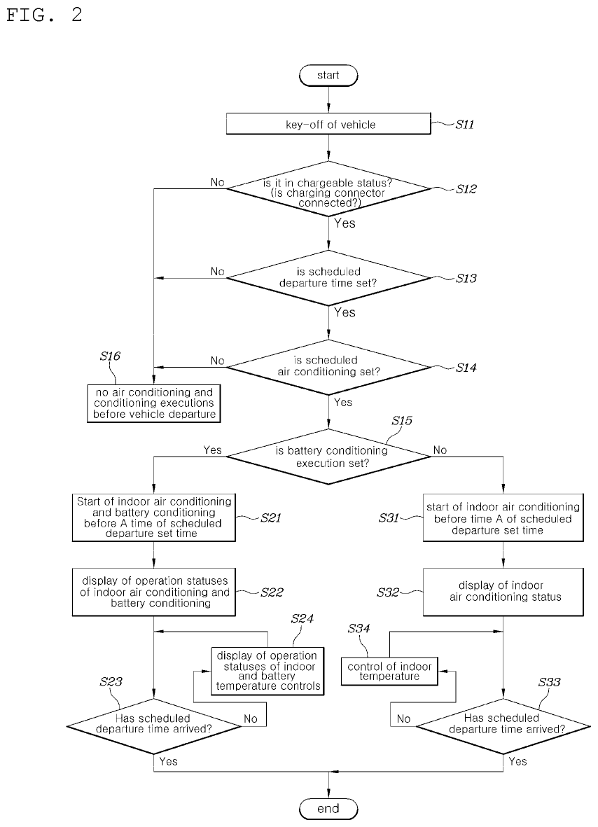

FIG. 2 is a flowchart illustrating a method for conditioning a vehicle battery interworking with scheduled air conditioning according to an exemplary embodiment of the present disclosure. The method for conditioning a vehicle battery interworking with scheduled air conditioning according to an exemplary embodiment of the present disclosure is implemented by the battery conditioning system described with reference to FIG. 1, and the operation and effect of the operation of the system for conditioning a vehicle battery interworking with scheduled air conditioning according to an exemplary embodiment of the present disclosure can be understood more clearly through the description of FIG. 2.

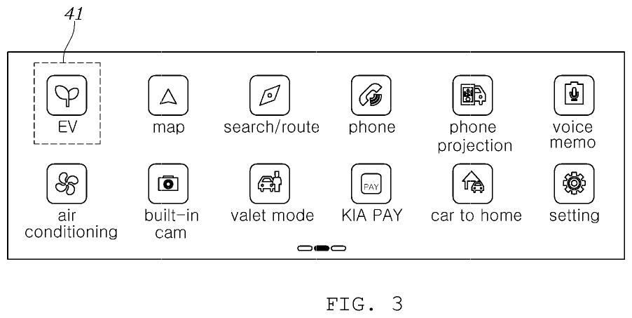

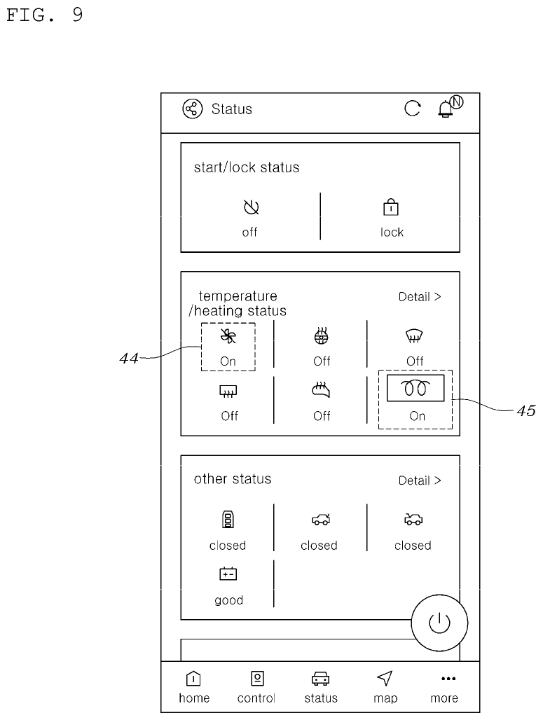

In addition, FIGS. 3 to 8 are views illustrating examples of a setting screen displayed on an AVN of a head unit of a vehicle in a system and method for conditioning a vehicle battery interworking with scheduled air conditioning according to an exemplary embodiment of the present disclosure, and FIG. 9 is a view illustrating an example of a screen displaying the statuses of the scheduled air conditioning execution and battery conditioning execution displayed on a driver terminal in a system and method for conditioning a vehicle battery interworking with scheduled air conditioning according to an exemplary embodiment of the present disclosure, with the on statuses indicated, e.g., by 44, 45.

Referring to FIGS. 2 to 9, the method for conditioning a vehicle battery interworking with scheduled air conditioning according to an exemplary embodiment of the present disclosure may perform, in the controller 10, particularly the VCU 11, determining whether the battery 100 of the vehicle is in a chargeable status (S12) after it is confirmed that the driver has finished driving and the vehicle is in a parked status by key-off (S11), and determining whether the scheduled departure time is set by the driver through the head units 20, 30 (S13), determining whether the scheduled air conditioning is set by the driver through the head units 20, 30 (S14), and determining whether the battery conditioning execution is set by the driver through the head units 20, 30 (S15) after it is confirmed that the vehicle battery is in a chargeable status.

The steps (S12 to S15) correspond to the steps in which the VCU 11 is configured to determine whether a requirement for the battery conditioning execution is satisfied. That is, the VCU 11 may be configured to execute the battery conditioning interworking with the scheduled air conditioning when it is determined that the battery 100 of the vehicle is in a chargeable status (S12), and it receives a setting for the scheduled departure time from the driver (S13), receives a setting for the air conditioning execution from the driver (S14), and receives the setting for the battery conditioning function execution (S15).

When it is determined in step (S11) that the vehicle is in the key-off status and the vehicle is in a chargeable status, the VCU 11 may be configured to provide the screen illustrated in FIGS. 3 to 8 so that the settings for the air conditioning execution, the battery conditioning execution, and the like are input on the screen of the AVN 20 of the vehicle head unit.

When the key-off of the vehicle is made in step (S11) and the vehicle is in a chargeable status, the VCU 11 may be configured to provide an initial screen in which the settings for the scheduled air conditioning execution, the battery conditioning execution, and the like can be input through the AVN 20, as shown in FIG. 3.

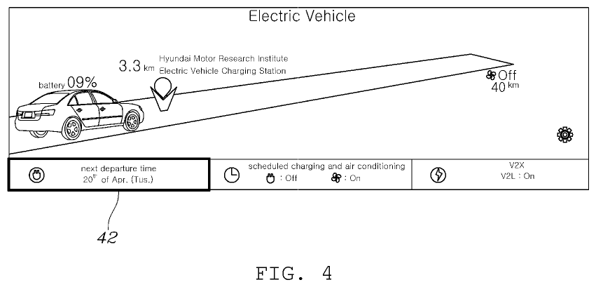

When the driver touches a screen area 41 in which the setting related to the scheduled air conditioning, the battery conditioning, and the like can be input on the initial screen, as shown in FIG. 3, the AVN 20 may be configured to provide a screen for executing the scheduled departure time and the scheduled air conditioning as shown in FIG. 4.

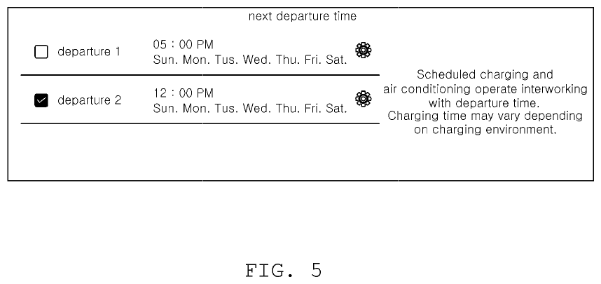

When the driver touches a screen area 42 for setting the scheduled departure time (next departure time) in FIG. 4, the AVN 20 is provided with a screen for inputting the scheduled departure time as shown in FIG. 5, and when the driver operates the screen to input the scheduled departure time, the VCU 11 may be configured to receive the scheduled departure time setting (S13), and may be configured to execute the scheduled air conditioning, the battery conditioning, and the like based on a following scheduled departure time.

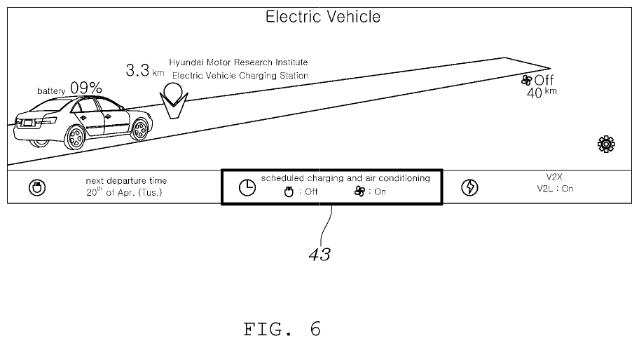

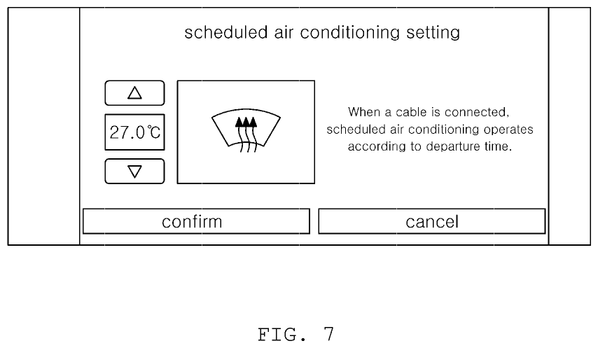

After the driver sets the scheduled departure time, the AVN 20 may be provided with a screen configured for inputting the scheduled air conditioning settings as shown in FIG. 6. When the driver touches a screen area 43 for the scheduled air conditioning setting on the screen as shown in FIG. 6, the AVN 20 provides a screen for the scheduled air conditioning setting as shown in FIG. 7. When the driver operates this screen to complete the scheduled air conditioning setting by inputting the scheduled air conditioning temperature and whether or not to be executed (S14), the VCU 11 may be configured to perform the scheduled air conditioning in consideration of the preset scheduled departure time setting.

In step (S13), the driver may input not only whether the scheduled air conditioning is executed, but also a time for which the scheduled air conditioning is executed and maintained, and the VCU 11 may be configured to reflect this setting and set the time at which the scheduled air conditioning starts. For example, the VCU 11 may be configured to turn on the power of the air conditioning controller 13 30 minutes before the scheduled departure time as an initial value to execute the scheduled air conditioning, and may be configured to determine the time to turn on the air conditioning controller 13 according to the corresponding set time when the scheduled air conditioning maintenance time is set by the driver.

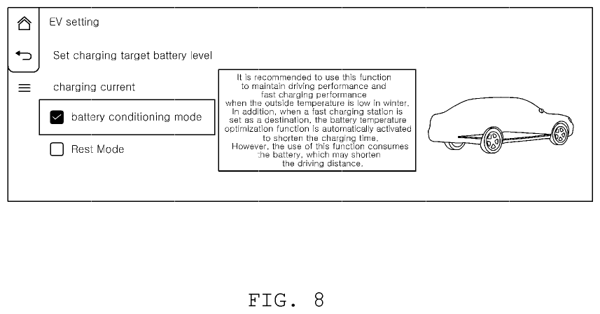

After the driver sets the departure time in the scheduled air conditioning setting, the AVN 20 may be configured to provide a screen for receiving an input of whether to execute the battery conditioning as shown in FIG. 8. When the driver inputs a setting for the scheduled conditioning execution on the screen, as shown in FIG. 8 (S15), the VCU 11 may be configured to execute the battery conditioning in consideration of the preset scheduled departure time setting.

On the other hand, step (S12) is to prevent excessive discharging of the battery due to the scheduled air conditioning and the battery conditioning, and to enable immediate charging when the status of charge of the battery falls below a preset reference level due to the execution of the scheduled air conditioning or battery conditioning.

However, since the scheduled air conditioning or the battery conditioning may be required in advance, even in a state in which the battery charging is impossible due to various driving conditions of the vehicle or the will of the driver, step (S12) may be selectively performed. That is, in an exemplary embodiment in which step (S12) is not performed, the VCU 11 may be configured to receive the scheduled departure time setting and the scheduled air conditioning setting regardless of whether the battery can be charged after the key-off of the vehicle (S11).

If it is set to execute the battery conditioning in step (S15), the VCU 11 may be configured to request the BMS 12 to power on the vehicle before the set scheduled departure time arrives to turn on the power of the vehicle. After the vehicle power is turned on, the VCU 11 may be configured to request the air conditioning controller 13 to control the air conditioning based on the set scheduled air conditioning temperature to make the vehicle inner air conditioning, and at the same time requests the BMS 12 to execute the conditioning of the battery 100 (S21).

The power turned on at the request of the VCU 11, in step (S21), may be the power providing power to the controller in charge of various controls performed before the driver boards the vehicle for actual vehicle driving, such as the scheduled air conditioning and battery conditioning of the vehicle, and the like.

In addition, in step (S21), the BMS 12 is configured to monitor the temperature of the battery 100 and operate the battery heater 110 when the temperature of the battery 100 is lower than a preset reference temperature, so that the battery conditioning can be executed in a way of heating the battery 100.

When the scheduled air conditioning and the battery conditioning are executed in step (S21), the communication module 30 of the vehicle head unit may be configured to provide the status of the scheduled air conditioning execution and battery conditioning execution to the driver terminal 40 (S22).

The screen displayed on the driver terminal 40 in the step (S22) may be configured in a manner of displaying whether the indoor air conditioning and battery conditioning function are executed on a screen displaying various statuses of the vehicle as shown in FIG. 9. In the driver terminal 40, an application for displaying the status of the vehicle through communication with the vehicle or providing instruction or setting of the driver to the vehicle may be installed, and the screen as shown in FIG. 9 may be displayed through this application.

In addition, various settings in the VCU 11 made in steps (S13 to S15) as described above may also be input by executing the application installed in the driver terminal 40 and through a setting screen provided by the application. The description screen provided by the application may also be implemented as a screen similar to that shown in FIGS. 3 to 8.

The start of the air conditioning and battery conditioning of the vehicle is calculated inversely based on the scheduled departure time to calculate the start time of the air conditioning and battery conditioning of the vehicle, and the air conditioning and battery conditioning of the vehicle can be executed at the calculated start time of the air conditioning and battery conditioning of the vehicle, respectively.

In general, the air conditioning and battery conditioning of the vehicle are executed simultaneously, but there are cases in which the air conditioning and battery conditioning of the vehicle are not simultaneously executed. Since the execution time of the air conditioning and battery conditioning of the vehicle may vary according to the preset battery reference temperature, it is necessary to calculate the start time of the air conditioning and battery conditioning of the vehicle, respectively, by the inverse calculation based on the scheduled departure time. If the air conditioning and battery conditioning of the vehicle are executed at the calculated start time of the air conditioning and battery conditioning of the vehicle, respectively, the temperature of the battery can be efficiently controlled in advance interworking with the indoor air conditioning executed in advance.

The indoor air conditioning and the battery conditioning may be continued until the scheduled departure time arrives (S23).

Until the scheduled departure time arrives, the indoor air conditioning and the battery conditioning may be executed in such a way that the temperature is kept constant by comparing the indoor temperature and the battery temperature with the air conditioning set temperature due to the driving and the preset reference temperature, respectively (S24).

For example, in step (S24), the air conditioning controller 13 is configured to compare the indoor set temperature input by the driver in setting the scheduled air conditioning with a measured indoor temperature, forming a first comparison, and can control the indoor temperature to be maintained at the set room temperature by turning on/off the indoor ventilation according to the resulting first comparison. In addition, the BMS 12 is configured to compare the preset reference temperature with the measured temperature of the battery 100, forming a second comparison, and is configured to control the temperature of the battery 100 to be maintained at a constant level by turning on/off the power of the battery heater 110 according to the resulting second comparison.

On the other hand, if it is not set to execute the battery conditioning in step (S15), the VCU 11 is configured to request the BMS 12 to power on the vehicle before the set scheduled departure time arrives to turn on the power of the vehicle. After turning on the power of the vehicle, the VCU 11 is configured to request the air conditioning controller 13 to control the air conditioning based on the set scheduled air conditioning temperature to execute the indoor air conditioning of the vehicle (S31).

Subsequently, in steps (S32 to S34), the indoor air conditioning in the same manner as the indoor air conditioning executed in the above-described steps (S22 to S24) may be performed, but the battery conditioning may not be executed.

As described above, the methods and systems for conditioning a vehicle battery interworking with scheduled air conditioning according to various embodiments of the present disclosure can appropriately control the temperature of the battery in advance interworking with the scheduled air conditioning of the vehicle, that is, the indoor air conditioning performed in advance during parking before departure of the vehicle.

Through this, the methods and systems for conditioning a vehicle battery interworking with scheduled air conditioning according to various embodiments of the present disclosure can make it possible to fully exhibit the battery performance from the time the vehicle starts, and prevent adverse effects on the life or deterioration of the battery.

In addition, the methods and systems for conditioning a vehicle battery interworking with scheduled air conditioning according to various embodiments of the present disclosure display the status of the battery conditioning execution through the driver terminal when executing the battery conditioning interworking with the scheduled air conditioning, so that the driver can be aware that the battery is always managed in the vehicle, and trust in the product can be improved.

In addition, in the methods and systems for conditioning a vehicle battery interworking with scheduled air conditioning according to various embodiments of the present disclosure, if the next departure time is set at the end of vehicle driving and only whether the scheduled air conditioning execution and conditioning execution are set in advance, the temperature of the battery can be automatically increased. Considering the characteristic that a lithium-ion battery mainly employed as a vehicle battery has a large specific heat, the method and system for conditioning a vehicle battery interworking with scheduled air conditioning according to an exemplary embodiment of the present disclosure can effectively control the battery temperature in terms of energy compared to the method in which the battery temperature is increased through a driver's separate manual operation.

As described above, although shown and described in relation to specific embodiments of the present disclosure, it will be apparent to one of ordinary skill in the art that the present disclosure can be variously improved and changed without departing from the spirit of the present disclosure provided by the following claims.

Therefore, embodiments of the present invention are not intended to limit the technical spirit of the present invention, but provided only for the illustrative purpose. The scope of the present disclosure should be construed on the basis of the accompanying claims, and all the technical ideas within the scope equivalent to the claims should be included in the scope of the present disclosure.

What is claimed is:

1. A method for conditioning a vehicle battery interworking with scheduled air conditioning, the method comprising:
using a controller:
determining whether a scheduled departure time and scheduled air conditioning execution are set after parking a vehicle;
determining whether battery conditioning execution of the vehicle is set when it is determined that the scheduled departure time and the scheduled air conditioning are set; and
executing air conditioning and battery conditioning of the vehicle before a preset reference time of the scheduled departure time when the battery conditioning execution is set.

2. The method according to claim 1, further comprising determining, using the controller, whether a charging connector for receiving a charging power from outside is connected to charge the battery.

3. The method according to claim 2, wherein when the charging connector is determined to not be connected, the scheduled air conditioning and battery conditioning of the vehicle are not executed using the controller.

4. The method according to claim 1, wherein the executing comprises:
executing indoor air conditioning of the vehicle to a temperature set in the setting of the scheduled air conditioning execution; and
increasing a temperature of the battery to a preset reference temperature.

5. The method according to claim 4, wherein the executing further comprises:
comparing the temperature set in the setting of the scheduled air conditioning execution with a measured indoor temperature of the vehicle, forming a first comparison;
turning on or off indoor ventilation, according to the comparison, to control an indoor temperature of the vehicle to be maintained to the temperature set in the setting of the scheduled air conditioning execution;
comparing the preset reference temperature with a measured temperature of the battery, forming a second comparison; and
turning on or off power of a battery heater provided in the battery according to the second comparison to control the temperature of the battery to be maintained to the reference temperature.

6. The method according to claim 1, wherein the executing comprises transmitting and displaying statuses of the scheduled air conditioning execution and battery conditioning execution to a remote communication terminal.

7. The method according to claim 1, wherein the executing comprises:
calculating a start time of the air conditioning and battery conditioning of the vehicle by inverse calculation based on the scheduled departure time; and
executing the air conditioning and battery conditioning of the vehicle respectively at the calculated start time of the air conditioning and battery conditioning of the vehicle.

8. A system for conditioning a vehicle battery interworking with scheduled air conditioning comprising:
an interface unit configured to receive a scheduled departure time setting, a scheduled air conditioning execution setting, and a conditioning execution setting of a battery in a vehicle after parking the vehicle; and
a controller configured to determine:
whether the scheduled departure time setting, the scheduled air conditioning execution setting, and the conditioning execution setting of the battery in the vehicle are received, and
whether, based on a resulting determination, to execute or not execute indoor air conditioning and battery conditioning of the vehicle before the scheduled departure time.

9. The system according to claim 8, wherein the controller is further configured to execute the battery conditioning when the scheduled departure time setting and the scheduled air conditioning execution setting are input.

10. The system according to claim 8, wherein the controller is further configured to:
determine whether a charging connector for receiving a charging power from outside is connected to charge the battery; and
execute the scheduled air conditioning and battery conditioning of the vehicle when it is determined that the charging connector is connected.

11. The system according to claim 8, wherein, when the indoor air conditioning and battery conditioning of the vehicle are executed before the scheduled departure time, the controller is further configured to:
execute the indoor air conditioning of the vehicle to a temperature set in the scheduled air conditioning execution setting; and
increase a temperature of the battery to a preset reference temperature.

12. The system according to claim 11, wherein the controller is further configured to:
compare the temperature set in the scheduled air conditioning execution setting with a measured indoor temperature of the vehicle, forming a first comparison,
turn on or off indoor ventilation, according to the first comparison, to control the indoor temperature of the vehicle to be maintained to the temperature set in the scheduled air conditioning execution setting,
compare the preset reference temperature with a measured temperature of the battery, forming a second comparison; and
turn on or off power of a battery heater provided in the battery, according to the second comparison, to control the temperature of the battery to be maintained to the reference temperature.

13. The system according to claim 8, further comprising a communication terminal configured to receive and display statues of the scheduled air conditioning execution and battery conditioning execution through the interface unit.
